(19) United States
(12) Patent Application Publication
(10) Pub. No.: US 2016/0068195 A1
(43) Pub. Date: Mar. 10, 2016

(54) BATTERY ARRANGEMENT IN A TWO-TRACK VEHICLE

(71) Applicant: VOLKSWAGEN AKTIENGESELLSCHAFT, Wolfsburg (DE)

(72) Inventors: Manuel HENTRICH, Dissen (DE); Uwen MALKE, Meine (DE); Dirk JÄSCHKE, Wolfsburg (DE); Ralf GÖDECKE, Hankensbüttel (DE)

(21) Appl. No.: 14/785,269

(22) PCT Filed: Mar. 7, 2014
(86) PCT No.: PCT/EP2014/054455

§ 371 Date: Oct. 16, 2015

(30) Foreign Application Priority Data
Apr. 18, 2013 (DE) 10 2013 006 702.2

(51) Int. Cl. B62D 21/15; H01M 2/10; B62D 21/11; B62D 65/02; B60L 11/18; B60K 1/04

(52) U.S. Cl. CPC B62D 21/157; B60L 11/1879; B60K 1/04; B62D 21/11; B62D 65/02; H01M 2/1083; B60K 2001/0438; H01M 2220/20

(57) ABSTRACT

The invention relates to a battery arrangement in a two-track vehicle, having a traction battery (5) with a battery housing (17) in which crash-sensitive battery cells (15) are arranged, and in which at least one crash cross-member (47) which runs in the transverse direction (y) of the vehicle is arranged, with which, in the event of a side crash, the applied impact force can be transmitted to the side of the vehicle at a distance from the crash, while bypassing the battery cells (15). According to the invention, the crash cross-member (47) is embodied at least in two parts with a battery-integrated centre part (49) which is lengthened outwardly with at least one deformation element (51) on the outside of the battery housing with the intermediate positioning of a free mounting gap (m) in the transverse direction (y) of the vehicle, and in particular, the deformation element (51) is mounted in directly or directly on a vehicle body part, in particular a vehicle body longitudinal member (31) or a door sill (13).

The invention relates to a battery array for a two-track vehicle according to the generic part of claim 1, to a vehicle having such a battery array according to claim 9 as well as to a method for assembling such a vehicle according to claim 10.

The traction battery of an electric vehicle has a housing that is configured to be a very stiff component and that has crash-sensitive cells in it. For safety reasons, these battery cells have to remain largely deformation-free in case of a side crash.

German patent application DE 10 2009 035 492 A1 discloses a generic battery array having a battery housing with crash cross members that run on the inside in the vehicle crosswise direction. Consequently, in case of a side crash, the battery housing can remain largely deformation-free since the crash cross member provides a force path along which the introduced impact energy is transmitted to the side of the vehicle facing away from the crash, where it can be dissipated. In this manner, the impact energy is transferred to the side of the vehicle facing away from the crash, thereby bypassing the battery cells.

The implementation of the above-mentioned force path entails the problem that the crash cross member is not a component of the vehicle body, but rather, it is an integral part of the battery housing. Once the traction battery has been installed, on the one hand, it is necessary to ensure a flawless transmission of power from the crash cross member on the battery side to the door sill or longitudinal member on the body side. On the other hand, simple installation of the traction battery in the vehicle body has to be ensured, namely, without a need for additional production work to join the crash cross member to the vehicle body.

The objective of the invention is to put forward a battery array in a vehicle, with which a sufficient energy-absorption capability is ensured in case of a side crash.

This objective is achieved by means of the features of claim 1, claim 9 or claim 10. Preferred refinements of the invention are disclosed in the subordinate claims.

The invention is based on the fundamental realization that, for reasons of production engineering, a great deal of assembly work is required to achieve a single-part configuration of the crash cross member on the battery side as well as a direct joining of the crash cross member to the lateral longitudinal members or to the door sills. Before this backdrop, according to the characterizing part of claim 1, the crash cross member is configured in at least two parts with a battery-integrated center part that is lengthened outwards by means of lateral deformation elements on the outside of the battery housing, and an open assembly gap is created in the vehicle crosswise direction. The lateral deformation elements can be mounted directly or indirectly onto the vehicle body, especially onto the chassis longitudinal member or onto the door sill. Therefore, the crash cross member according to the invention is not configured so as to be continuous in the vehicle crosswise direction, but rather, it has a total of three parts, namely, the center part situated inside the battery housing and the two deformation elements arranged so as to be aligned outwards in the vehicle crosswise direction. Moreover, an open assembly gap keeps the deformation elements at a distance from the center part of the crash cross member on the battery housing side in order to ensure a simple installation of the deformation elements as well as of the traction battery on the vehicle body.

In the case of a side crash, first of all, the longitudinal member or the door sill facing the crash is compressed and the associated deformation element of the crash cross member is deformed. Subsequently, the remaining impact energy is transmitted via the center part of the crash cross member all the way to the side of the vehicle facing away from the crash. Under certain circumstances, the center part of the crash cross member can come into contact with the deformation element facing away from the crash, thereby bypassing the free assembly gap, and the deformation element as well as the door sill or the vehicle longitudinal member facing away from the crash can be deformed.

In order to further improve the crosswise stiffness, the deformation element can be mounted directly onto a rear axle of the vehicle. As seen in the crosswise direction of the vehicle, the rear axle can have two opposing steering knuckles for each of the rear wheels of the vehicle. Each steering knuckle is articulated at bearings on the vehicle body side via at least one control arm. The deformation element of the crash cross member can preferably be arranged directly on the bearing of the control arm on the vehicle body side. Moreover, the center part of the crash cross member integrated into the traction battery can extend in the vehicle crosswise direction, especially in alignment, between the two bearings of the control arm on the body side. This results in a markedly improved crosswise stiffness of the vehicle in case of a side crash.

The bearing of the control arm on the vehicle body side can have a bearing bracket which is rigidly mounted on the vehicle body and on which the control arm is pivotally mounted by means of a pivot bearing. In this context, the deformation element is mounted especially on the bearing bracket. Therefore, the bearing bracket is employed as a support base not only for the control arm but rather also for the deformation element.

As mentioned above, on each side of the vehicle, there is at least one control arm between the steering knuckle and a bearing on the vehicle body side. This control arm can be a component of the multi-control arm unit of a wheel suspension which additionally has other control arms that are pivotally mounted between the steering knuckle and the vehicle body, especially a subframe on the vehicle body side.

It is not only the above-mentioned control arms that can be articulated onto the subframe. In addition, drive components, for instance, a rear-axle differential and/or a track rod, can be mounted on the subframe. The subframe can be mounted on the bearings on the vehicle body, that is to say, on the chassis longitudinal members. In order to improve the component stiffness of the subframe, the latter can be configured so as to be approximately rectangular and having subframe longitudinal members and subframe cross members.

The vehicle can be assembled with a high degree of flexibility owing to the multi-part configuration of the crash cross member, which consists of the two lateral deformation elements as well as the center part on the battery housing side. For example, the two deformation elements, together with the rear axle, form a pre-assembly unit that is prefabricated independently of the battery housing with the crash cross-member center part integrated therein. The battery housing as well as the rear axle can be mounted independently of each other on the vehicle body, that is to say, at different joining places.

The traction battery can have an undercut with a free space. Once the vehicle has been assembled, the rear axle can project into the free space, namely, in such a way that the rear axle and the traction battery overlap with a certain overhang as seen in the vertical direction of the vehicle.

The assembly sequence during the assembly of the battery array and of the rear axle on the vehicle body will be described below, and this is only possible owing to the inventive multi-part configuration of the crash cross member. Thus, in a first assembly step, the vehicle rear axle is placed into a pre-assembly position on a positioning frame. During the assembly of the vehicle, the positioning frame serves as an assembly aid for joining the running gear, the traction battery as well as the front and/or rear axle to the vehicle body. In a second assembly step, the traction battery is placed into a final assembly position on the positioning frame. Subsequently, in a third assembly step, the vehicle rear axle is moved from its pre-assembly position into its final assembly position. In its final assembly position, the rear axle and the traction battery are arranged so as to be nested into each other, that is to say, the vehicle rear axle projects into the above-mentioned undercut of the traction battery so that the rear axle overlaps the traction battery with a certain overhang. The traction battery and the vehicle rear axle, which are now both in the final assembly position on the positioning frame, are subsequently joined to the vehicle body in a fourth assembly step.

The advantageous embodiments and/or refinements of the invention explained above and/or presented in the subordinate claims can be employed individually or else in any desired combination with each other, except, for instance, in those cases of clear-cut dependencies or incompatible alternatives.

The invention and its advantageous embodiments and/or refinements as well as their advantages will be explained in greater detail below on the basis of drawings.

The following is shown:

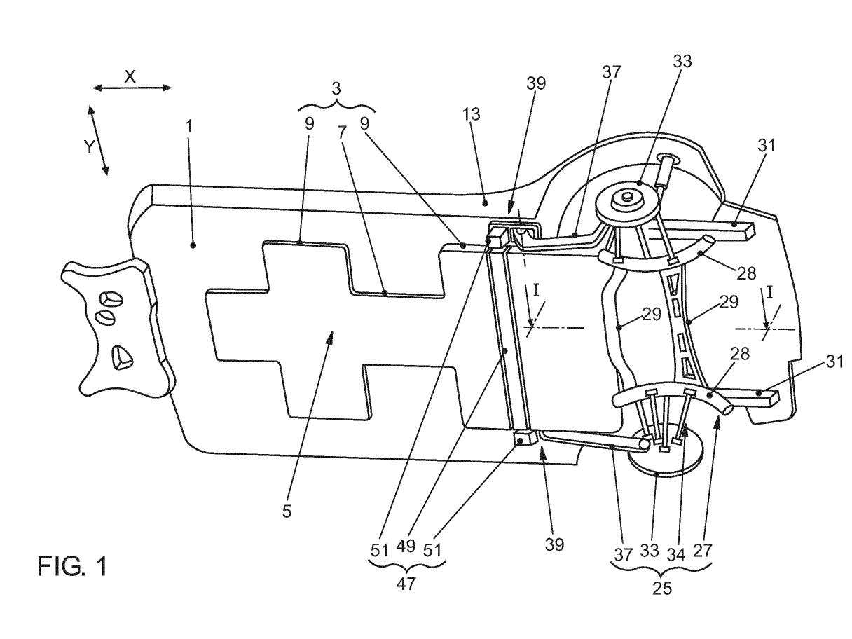

FIG. 1: a perspective view from below of the undercarriage of a vehicle with a traction battery as well as a rear axle mounted on it;

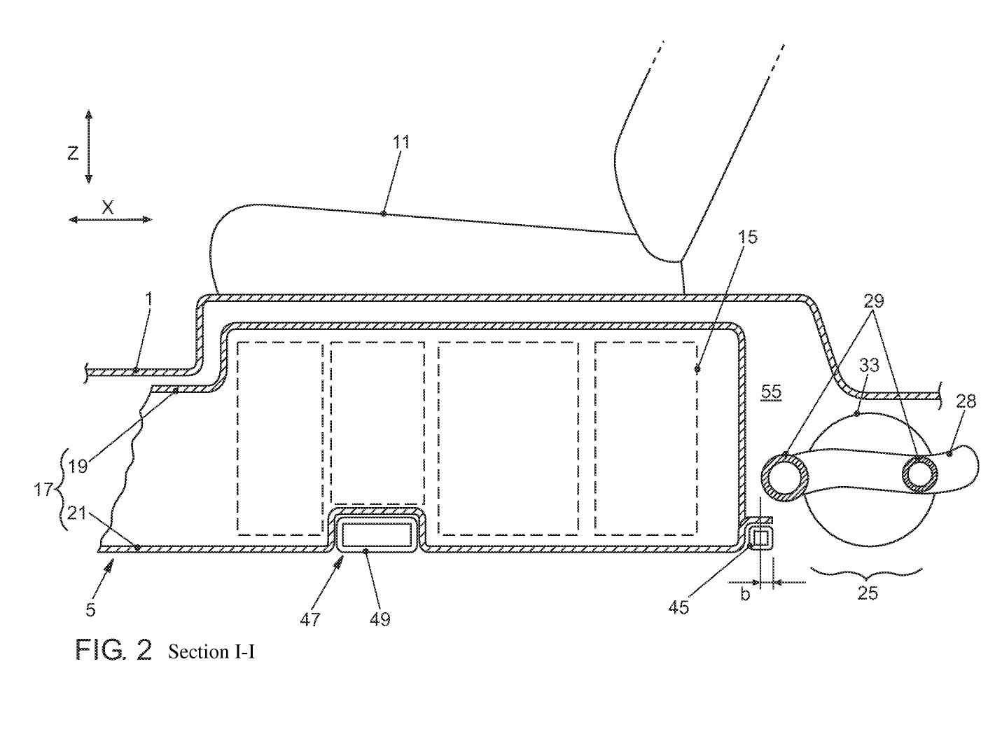

FIG. 2: a partial cutout view of the sectional plane I-I of FIG. 1;

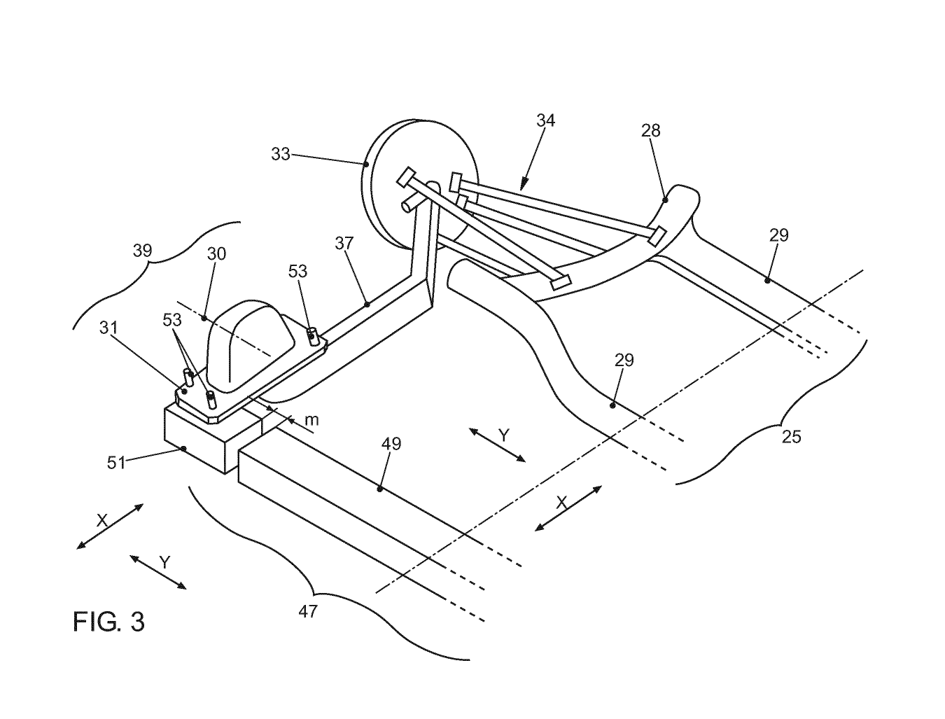

FIG. 3: a bearing of a control arm on the vehicle body side of the wheel suspension of the vehicle rear axle; as well as

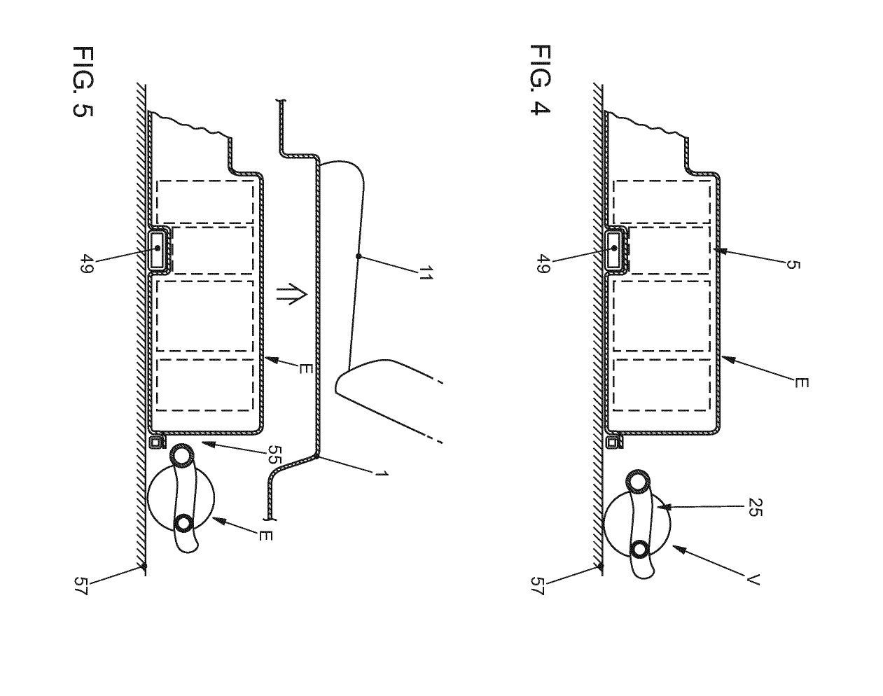

FIGS. 4 and 5: views illustrating the assembly steps for assembling the battery array as well as the vehicle rear axle on the vehicle body.

FIG. 1 shows a perspective view from below of the undercarriage of an electric vehicle shown in a greatly simplified form. For the sake of clarity, the only components depicted are those that are necessary for an understanding of the invention. Thus, FIG. 1 shows a floor pan 1 that delimits the vehicle interior on the floor side and that has a holding contour 3 where a traction battery 5 can be arranged. The holding contour 3 in the floor pan 1 has a center tunnel 7 that projects into the vehicle interior in the vehicle longitudinal direction x and it also has lateral projections 9 below the front seat of the vehicle as well as below the back seat 11 (FIG. 2).

According to FIG. 1, the lateral protrusions 9 of the battery-holding contour 3 extend all the way to the side door sills 13. Accordingly, the traction battery 3 also extends all the way to the vicinity of the side door sills 13.

The traction battery 5 has cells 15 (indicated by broken lines in FIG. 2) that are arranged in a battery box 17. The battery box 17 consists of shell-shaped upper and lower parts 19, 21 (FIG. 2) which are screwed to screwing sites on the vehicle floor 1, for example, to a joining flange protruding at the edges.

Moreover, a rear axle 25 is mounted at the rear of the undercarriage of the vehicle. The vehicle rear axle 25 has an approximately rectangular subframe 27 that is in the form of a tubular structure and that is made up of subframe longitudinal members 28 as well as subframe cross members 29. The subframe 27 serves as a support base for drive components such as, for instance, a rear axle differential. Moreover, the subframe 27 is mounted at bearings (not shown here) on the two chassis longitudinal members 31 (FIG. 1). In a known manner, the subframe 27 is also articulated by means of a multi-control arm unit 34 onto side steering knuckles 33 for the rear wheels (not shown here).

As can be also be seen in FIG. 1, each of the multi-control arm units 34 has a longitudinal control arm 37 that projects forward in the vehicle longitudinal direction x. Each longitudinal control arm 37 is articulated, on the one hand, onto the steering knuckle 33 and, on the other hand, not onto the subframe 27, but rather directly onto the vehicle body, namely, on a bearing 39 on the vehicle body side. FIG. 3 shows an enlarged view of the bearing 39 of the control arm 37 on the vehicle body side. Consequently, the bearing 39 consists of a bearing bracket 41 which is mounted on the vehicle body and on which the longitudinal control arm 37 is pivotally mounted by means of a pivot bearing 30. The bearing bracket 41 is mounted rigidly on the vehicle body.

With an eye towards improving the crosswise stiffness, the battery box 17 of the traction battery 5 is provided with an appropriate stiffening structure. According to FIG. 2, this stiffening structure has, for instance, diagonal members 45 and a crash cross member 47. As shown in FIG. 1, the crash cross member 47 extends in the vehicle crosswise direction y so as to be aligned between the two bearings 39 of the longitudinal control arms 37 on the body side. Moreover, the crash cross member 47 is configured so as to not be continuous in the crosswise direction y, but rather so as to consist of a total of three parts, that is to say, a center part 49 integrated into the battery box 17 and deformation elements 51 laterally adjacent thereto. An existing assembly gap m keeps the two deformation elements 51 at a distance from the center part 49 on the battery side (FIG. 3).

According to FIG. 3, the deformation elements 51 are not mounted directly onto the vehicle body, but rather joined in a screwed connection 53 onto the bearing bracket 41 of the bearing 39 of the longitudinal control arm 37 on the vehicle body side.

In the case of a side collision, first of all, the door sill 13 facing the crash is deformed—together with the deformation element 51 facing the crash—in the crosswise direction y, thereby occupying the assembly gap m until coming into contact with the crash cross-member center part 49 on the battery side. Subsequently, the impact energy is transmitted all the way to the side of the vehicle facing away from the crash, thereby bypassing the battery cells 15. If applicable, while occupying the assembly gap m, the crash cross-member center part 49 can be pressed against the deformation element 51 facing away from the crash.

As can be seen in the preceding description, the cross-member center part 49 as well as the two deformation elements 51 are each components of pre-assembly units that are separate from each other, that is to say, the traction battery 5 as well as the vehicle rear axle 25. This allows a considerably more flexible assembly sequence during the assembly of the vehicle in comparison to the approach in which a crash cross member 47 is configured as a single part.

FIG. 2 shows the vehicle is in its assembled state, in which the traction battery 5 and the rear axle 25 are nested with respect to each other. Consequently, the rear of the traction battery 5 has an undercut with a free space 55. A front subframe cross member 29 projects into the free space 55, namely, with an overhang b (FIG. 2). This translates into a package-optimized assembly that requires the assembly steps shown below in FIGS. 4 and 5. Thus, in a first assembly step (FIG. 4), first of all, the vehicle rear axle 25 is placed in a pre-assembly position V on a positioning frame 57 that is employed as an assembly aid. In a second assembly step (FIG. 5), the traction battery 5 is already situated in its final installation position E on the positioning frame 57. Subsequently, in a third assembly step (FIG. 5), the vehicle rear axle 25 is moved from its pre-assembly position V into its final assembly position E. In its final assembly position E, the vehicle rear axle 25 is pushed with the overhang b into the free space 55 provided by the traction battery 5. Subsequently, in a fourth assembly step, the traction battery 5 as well as the vehicle rear axle 25, which are now both in the final assembly position, are joined to the vehicle body.

1. A battery array for a two-track vehicle, comprising:
a traction battery that has a housing in which crash-sensitive battery cells and at least one crash cross member that runs in a transverse direction of the vehicle are arranged, with which, in case of a side crash, the introduced impact energy can be transmitted to a side of the vehicle facing away from the crash, thereby bypassing the battery cells,
wherein the crash cross member is configured in at least two parts with a battery-integrated center part that is lengthened outwards by means of at least one deformation element on the outside of the battery housing and with the creation of an open assembly gap in the vehicle transverse direction and
wherein the deformation element is mounted directly or indirectly onto a part of the chassis.

2. The battery array according to claim 1,
wherein the deformation element is mounted on a rear axle of the vehicle,
wherein, as seen in the transverse direction of the vehicle, especially the rear axle has two opposing steering knuckles for the rear wheels of the vehicle, each steering knuckle being articulated onto bearings on the vehicle body side via at least one control arm, and
wherein the deformation element of the crash cross member is arranged directly on the bearing of the control arm on the vehicle body side.

3. The battery array according to claim 1, wherein the crash cross member of the traction battery extends in the vehicle transverse direction, between the bearings on the body side.

4. The battery array according to claim 1,
wherein the bearing of the control arm on the vehicle body side has a bearing bracket which is rigidly mounted on the vehicle body and on which the control arm is pivotally mounted by means of a pivot bearing, and
wherein the deformation element is mounted on the bearing bracket.

5. The battery array according to claim 2, wherein the control arm is a component of the multi-control arm unit of a wheel suspension which has a number of additional control arms that are pivotally mounted between the steering knuckle and a subframe.

6. The battery array according to claim 5,
wherein the subframe is mounted on bearings on the vehicle body, and/or
wherein the subframe is configured so as to be approximately rectangular with subframe longitudinal members and subframe cross members.

7. The battery array according to claim 2, wherein the battery housing with the crash cross member integrated therein and the rear axle with the deformation elements mounted thereon constitute two separate pre-assembly units that are independent of each other and that can be mounted at different joining places on the vehicle body.

8. The battery array according to claim 2, wherein the traction battery has an undercut with a free space into which the rear axle projects in such a way that the rear axle and the traction battery overlap with an overhang as seen in a vertical direction of the vehicle.

9. A vehicle with a battery array according to claim 2.

10. A method for assembling a vehicle having a battery array according to claim 1, comprising:
placing the vehicle rear axle is placed in a pre-assembly position on a positioning frame,
placing the traction battery is placed in a final installation position on the positioning frame,
moving the vehicle rear axle is moved from its pre-assembly position into its final assembly position in which the vehicle rear axle is pushed into a free space of an undercut of the traction battery, so that the vehicle rear axle and the traction battery overlap with an overhang as seen in the vertical direction of the vehicle, and
joining the traction battery and the vehicle rear axle, which are now both in the final assembly position to the vehicle body.

11. The battery array according to claim 1, wherein the deformation element is mounted to a chassis longitudinal member of the chassis or a door sill of the chassis.

12. The battery array according to claim 6, wherein the subframe is mounted on bearings on chassis longitudinal members of the vehicle body.
